(19) United States
(12) Patent Application Publication
(10) Pub. No.: US 2026/0036819 A1
(43) Pub. Date: Feb. 5, 2026

(54) IMAGE DISPLAY APPARATUS EASILY SWITCHABLE BETWEEN HEAD-MOUNTED DISPLAY FORM AND HAND-HELD DISPLAY FORM

(71) Applicant: CANON KABUSHIKI KAISHA, Tokyo (JP)

(72) Inventors: TOSHIHARU KAWAI, Kanagawa (JP); MARINA KITAKAMI, Tokyo (JP)

(21) Appl. No.: 19/264,724

(22) Filed: Jul. 9, 2025

(30) Foreign Application Priority Data
Jul. 30, 2024 (JP) 2024-123336

(51) Int. Cl. G02B 27/01

(52) U.S. Cl. CPC G02B 27/0176; G02B 27/0172; G02B 2027/0156; G02B 2027/0161

(57) ABSTRACT

An image display apparatus includes a display unit configured to display an image, and a support unit configured to support the display unit and to be mountable on a user's head. The support unit includes a deformation portion configured to bend at a predetermined part and drop down below the display unit.

### BACKGROUND

### Field of the Technology

The present disclosure relates to an image display apparatus easily switchable between a head-mounted display (HMD) form and a hand-held display (HHD) form.

### Description of the Related Art

In recent years, a head-mounted display (HMD) that is mounted on a user's head to display an image in front of the user's eyes has been used as an image display apparatus. The HMD is used as a device with which a user can experience virtual reality (VR) and mixed reality (MR) because the user can easily view an image on a large virtual screen and easily view a stereoscopic image. The HMD is expected to be used for various kinds of observations or the like as the HMD is mounted on the user's head to allow the user to be hands-free.

Other than the apparatus configuration to be mounted on the user's head such as an HMD, a hand-held type apparatus configuration such as a hand-held display (HHD) is also used as an image display apparatus with which a user can experience VR or MR. The HHD is provided with an image display unit having a grip portion capable of being gripped by a user and is usable for observations in a manner simpler than the HMD.

Japanese Patent No. 6719868 discusses an apparatus configuration in which the same image display apparatus can be used in the HMD form or the HHD form by replacing a component to switch between them. However, with the apparatus configuration discussed in Japanese Patent No. 6719868, it takes time and labor to switch between the HMD form and HHD form. An issue therefore arises when a user who wants to use the image display apparatus in the HMD form and another user who wants to use the image display apparatus in the HHD form frequently alternate, and both forms need to be prepared for the users.

### SUMMARY

In consideration of the above-described issue, the present disclosure is directed to an image display apparatus usable in a head-mounted display (HMD) form or a hand-held display (HHD) form and easily switchable between the HMD form and the HHD form without adding or changing any component.

According to an aspect of the present disclosure, an image display apparatus includes a display unit configured to display an image, and a support unit configured to support the display unit and to be mountable on a user's head, wherein the support unit includes a deformation portion configured to bend at a predetermined part and drop down below the display unit.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram of a perspective view illustrating an image display unit of an image display apparatus according to a first exemplary embodiment.

FIG. 2A is a diagram of a front view illustrating a state in which a user performs an operation to decrease a distance between eye portions of the image display unit according to the first exemplary embodiment.

FIG. 2B is a diagram of a front view illustrating a state in which a user performs an operation to increase a distance between eye portions of the image display unit according to the first exemplary embodiment.

FIG. 3 is a diagram of a perspective view illustrating an opposite side of the image display unit illustrated in FIG. 1.

FIG. 4 is a diagram of a perspective view illustrating a state in which a user wears the image display apparatus according to the first exemplary embodiment in a head-mounted display (HMD) form on the user's head.

FIG. 5 is a diagram of a side view illustrating a state in which a user wears the image display apparatus according to the first exemplary embodiment in the HMD form on the user's head.

FIG. 6 is a diagram of a side view illustrating a state in which a user wears the image display apparatus according to the first exemplary embodiment in the HMD form on the user's head.

FIG. 7 is a diagram of a perspective view illustrating a state in which a user grips the image display apparatus according to the first exemplary embodiment in a hand-held display (HHD) form.

FIG. 8 is a diagram of a side view illustrating a state in which a user grips the image display apparatus according to the first exemplary embodiment in the HHD form.

FIG. 9 is a schematic diagram illustrating a head mounting unit of the image display apparatus according to the first exemplary embodiment in the HHD form as seen from above.

FIG. 10A is a diagram of a perspective view illustrating a state in which a user wears an image display apparatus according to a second exemplary embodiment in an HMD form on the user's head.

FIG. 10B is a diagram of a perspective view illustrating the image display apparatus according to the second exemplary embodiment in the HMD form as seen from a back side.

FIG. 11 is a diagram of a perspective view illustrating a state in which a user grips the image display apparatus according to the second exemplary embodiment in an HHD form.

FIG. 12A is a diagram of a side view illustrating the image display apparatus according to the second exemplary embodiment in the HMD form.

FIG. 12B is a diagram of a side view illustrating the image display apparatus according to the second exemplary embodiment in the HHD form.

FIG. 13A is a schematic diagram illustrating a mechanism of the image display apparatus according to the second exemplary embodiment in which a deformation portion and an additional deformation portion interlock with each other in the HMD form.

FIG. 13B is a schematic diagram illustrating the mechanism of the image display apparatus according to the second exemplary embodiment in which the deformation portion and the additional deformation portion interlock with each other in the HHD form.

### DESCRIPTION OF THE EMBODIMENTS

### Overall Configuration of Image Display Apparatus in Exemplary Embodiments

An overall configuration of an image display apparatus according to exemplary embodiments will be described before disclosing the specific exemplary embodiments.

The image display apparatus according to the present disclosure includes a display unit for displaying an image, and a support unit for supporting the display unit to enable the image display apparatus to be mounted on a user's head. The support unit can bend at predetermined parts and has a deformation portion bending at the predetermined parts to allow at least a portion of the deformation portion to drop down below the display unit. The image display apparatus can be used in any one of a first use form (head-mounted display (HMD) form) or a second use form (hand-held display (HHD) form) in a selective manner as the support unit has the deformation portion. More specifically, in a state where the deformation portion is not deformed, i.e., the deformation portion is not bent at the predetermined parts, the image display apparatus is in the first use form in which the support unit is to be mounted on the user's head. In a state where the deformation portion is deformed, i.e., the deformation portion is bent at the predetermined parts, the image display apparatus is in the second use form in which the support unit is to be gripped by a user. In the second use form, a portion (portion contacting the back of the user's head in the first use form) of the deformation portion drops down below the user's head due to the deformation, and the user can grip the portion, which serves as a grip portion, naturally and stably. As described above, an image display apparatus switchable between an HMD form and an HHD form without adding or changing any component and usable in any one of the HMD form or HHD form is achieved in the present disclosure.

In the first use form, because belt portions of the support unit need to be adjusted to match the circumferential length of the user's head, it is desirable that the belt portions are fully flexible and elastic. On the other hand, in the second use form, the belt portions included in the deformation portion drop down below the display unit, and the display unit is required to be held stably when the user grips the grip portion. Accordingly, in the present disclosure, the deformation portion has a configuration in which the stiffness of the deformation portion increases when the deformation portion is bent at the predetermined parts. More specifically, the deformation portion is rotatably connected with the grip portion at two rotatable predetermined parts to form an arc shape, and rotational axis directions of the two predetermined parts are configured so as to intersect with each other. In this case, the belt portions of the deformation portion are twisted to increase the stiffness thereof when the deformation portion deforms to shift the image display apparatus from the first use form to the second use form, and the belt portions become less easily displaceable in the lengthwise direction. In this way, the belt portions become stiff in a state where the belt portion has dropped down, and a user can hold the display unit stably.

As described above, according to the present disclosure, it is possible to satisfy both the flexibility of the belt portions required in the first use form, and the position stability of the display unit required in the second use form.

In the present disclosure, additional deformation portions provided in parallel with the deformation portion, stiffer than the deformation portion, and bending to drop down in conjunction with the bending operation of the deformation portion may be further provided. With this configuration, the belt portions of the deformation portion are reinforced by the additional deformation portions, and the display unit can be stably held when the deformation portion is deformed to shift the image display apparatus from the first use form to the second use form. This configuration is suitable to be applied to a configuration in which the support unit includes a pair of deformation portions having grip portions (rear head contact portions) separated from each other.

### Specific Description of Exemplary Embodiments

Hereinbelow, with reference to the attached drawings, various exemplary embodiments of the present disclosure will be described in detail. Note that the exemplary embodiments described below are not intended to limit the present disclosure according to the claims. In the exemplary embodiments, a plurality of features is described, but not all the features are necessarily essential, and the plurality of features may be arbitrarily combined. In the attached drawings, the same or similar components may be assigned the same reference numbers, and redundant descriptions thereof are omitted. In the exemplary embodiments described below, as for a pair of components arranged on the left side and the right side, the left-side component is assigned L and the right-side component is assigned R to distinguish the pair of components.

A first exemplary embodiment according to the present disclosure will be described.

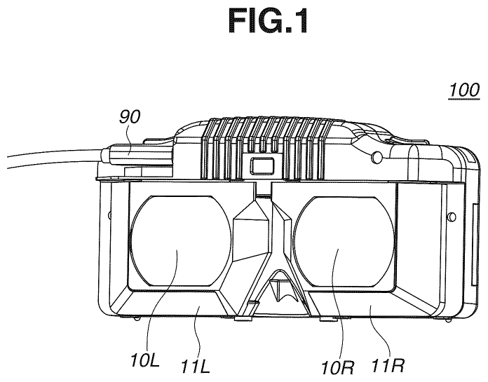

FIG. 1 is a diagram of a perspective view illustrating an image display unit 100 of an image display apparatus according to the present exemplary embodiment.

The image display unit 100 is a display unit according to the present disclosure and includes lenses 10L and 10R. A user observes an image through the lenses 10L and 10R. The lenses 10L and 10R are prisms or lenses for enlarging an image and guiding light on a liquid crystal display (LCD) or an organic light-emitting display (OLED) (not illustrated) arranged in the image display unit 100. Hoods 11L and 11R are provided around the lenses 10L and 10R, respectively.

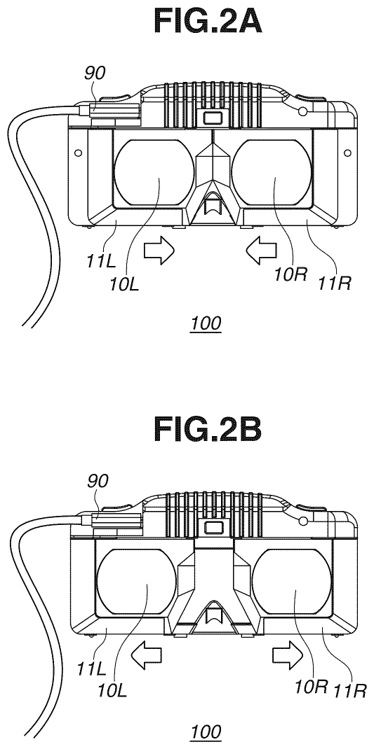

FIGS. 2A and 2B are diagrams of front views each illustrating a state in which a user operates the hoods 11L and 11R of the image display unit 100 according to the present exemplary embodiment.

The user can adjust the positions of the lenses 10L and 10R to the left or the right to match the user's eye distance (i.e., distance between the user's eyes) by operating the hoods 11L and 11R. FIG. 2A illustrates a case of adjusting the eye distance to be narrower, and FIG. 2B illustrates a case of adjusting the eye distance to be wider.

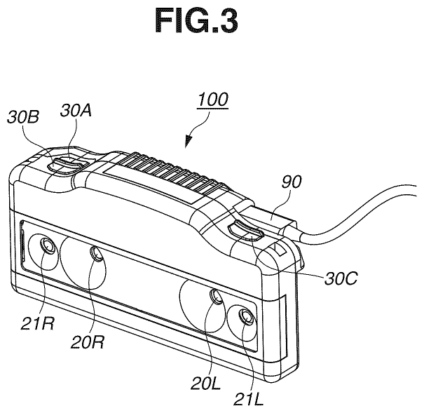

FIG. 3 is a diagram of a perspective view illustrating an opposite side of the image display unit 100 illustrated in FIG. 1.

The image display unit 100 includes image capturing cameras 20L and 20R and alignment cameras 21L and 21R. The image capturing cameras 20L and 20R are a stereo camera that captures an actual image of a surrounding area for displaying the captured actual image to the user via the lenses 10L and 10R. The alignment cameras 21L and 21R are a stereo camera that obtains a position and attitude of the image display unit 100 using a feature point such as a marker and an edge of an object from a captured image. The alignment cameras 21L and 21R are monochrome cameras, aiming for a high accuracy and a high fault tolerance alignment using a wide angle of view, a high shutter speed, a long base line length, and the like.

In the present exemplary embodiment, the alignment cameras 21L and 21R are provided separately from the image capturing cameras 20L and 20R, but it is also possible to obtain a display image and alignment information only by the image capturing cameras 20L and 20R. Instead of the alignment cameras 21L and 21R, a distance sensor using an ultrasonic wave or an infrared beam can be employed.

The image display unit 100 exchanges the position and attitude information and the captured actual image with an external personal computer (PC) or an external controller (not illustrated) via a cable 90 to generate and display a display image obtained by superimposing computer graphics on the captured actual image. A user can observe the display image through the lenses 10L and 10R. The image display unit 100 is provided with operation buttons 30A, 30B, and 30C to enable a user to perform instruction operations and a power control operation using the operation buttons 30A, 30B, and 30C.

According to the present exemplary embodiment, the image display apparatus in the HMD form is the first use form.

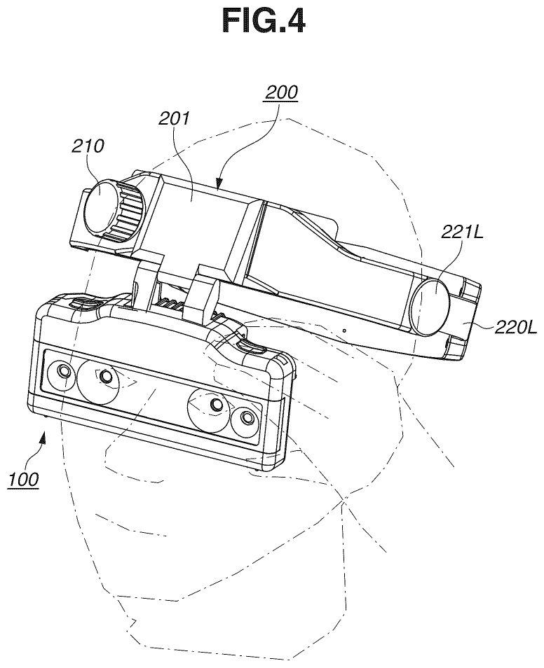

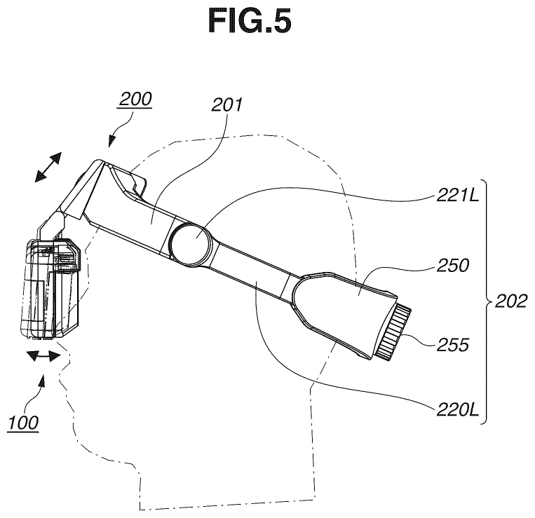

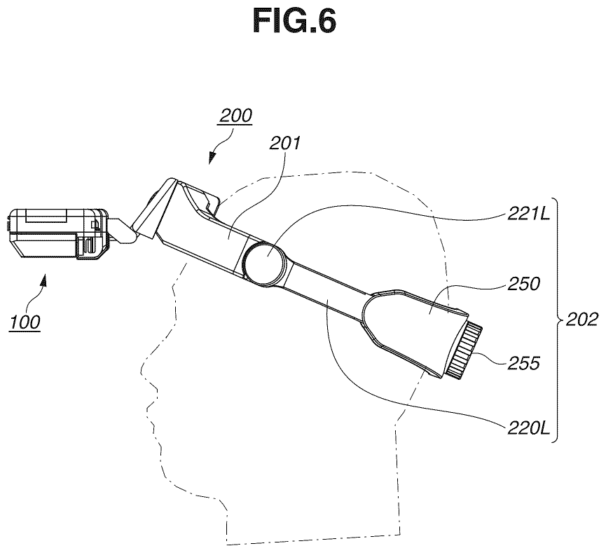

FIG. 4 is a diagram of a perspective view illustrating a state in which a user wears the image display apparatus according to the present exemplary embodiment in the HMD form on the user's head. FIGS. 5 and 6 are diagrams of side views each illustrating a state in which a user wears the image display apparatus according to the present exemplary embodiment in the HMD form on the user's head.

The image display apparatus includes the above-described image display unit 100 for displaying an image, and a head mounting unit 200 that is a support unit for supporting the image display unit 100 to allow the user to wear the image display apparatus on the user's head. The head mounting unit 200 includes a forehead contact portion 201 that is a first contact portion with which the user's forehead is brought into contact when the user wears the image display apparatus, and a deformation portion 202 extending in an arc shape. The deformation portion 202 includes strip-shaped belts 220L and 220R made of a flexible material, rotation portions 221L and 221R respectively connecting the forehead contact portion 201 and the belts 220L and 220R, and a rear head (back of the head) contact portion 250 serving as a second contact portion with which the user's rear head is brought into contact when the user wears the image display apparatus. The image display unit 100 is swingably connected and fixed to the forehead contact portion 201.

In the HMD form, the deformation portion 202 becomes circular-shaped (ring-shaped), connected integrally with the forehead contact portion 201 without bending (non-bending state) at the rotation portions 221L and 221R. The user can observe an image in a hands-free manner by wearing the head mounting unit 200 with the image display unit 100 connected thereto on the user's head.

In the HMD form, as illustrated in FIG. 5, the user swings the image display unit 100 with respect to the forehead contact portion 201. The forehead contact portion 201 has a vertical direction adjustment dial 210. By operating the vertical direction adjustment dial 210 to appropriately move the image display unit 100 vertically, in combination with the eye distance adjustment function, the user can adjust the positions of the lenses 10L and 10R to optimal observation positions with respect to the user.

The rear head contact portion 250 has a belt adjustment dial 255. Operating the belt adjustment dial 255 enables the length of the belts 220L and 220R in an extending direction to be adjusted to match the circumferential length of the user's head, due to the operation of a rack-and-pinion arranged in the rear head contact portion 250.

As illustrated in FIG. 6, by making the swing range of the image display unit 100 large, it is possible to move the image display unit 100 to a flip-up position (non-observation position). In this way, the user can directly observe the surrounding area temporarily without removing the head mounting unit 200 from the user's head. In the present exemplary embodiment, as illustrated in FIG. 3, the cable 90 is connected so as to extend from the side of the image display unit 100. In this way, the image display unit 100 can be moved to the flip-up position without the cable 90 interfering with the head mounting unit 200.

As illustrated in FIG. 4, the user can appropriately operate the operation buttons 30A, 30B, and 30C while holding the image display unit 100 so as not to move the image display unit 100 with respect to the user's head by gripping the top and bottom of the image display unit 100 with the user's hand.

The image display apparatus according to the present exemplary embodiment can be shifted from the HMD form to the HHD form, which serves as the second use form, by deformation of the deformation portion 202.

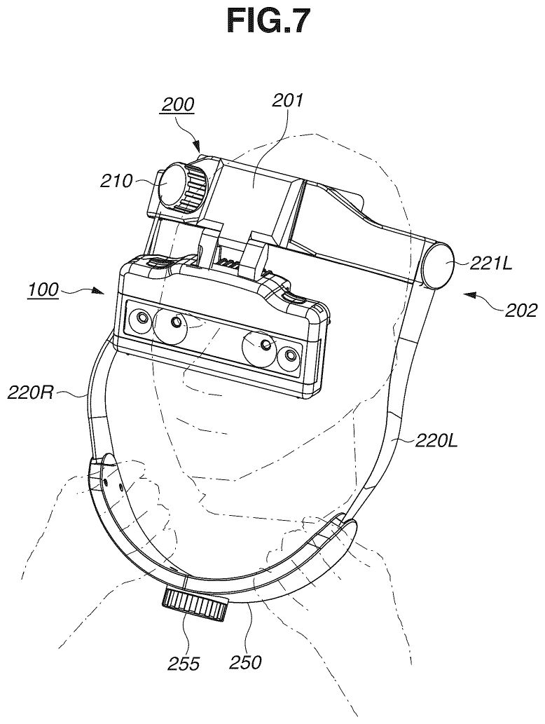

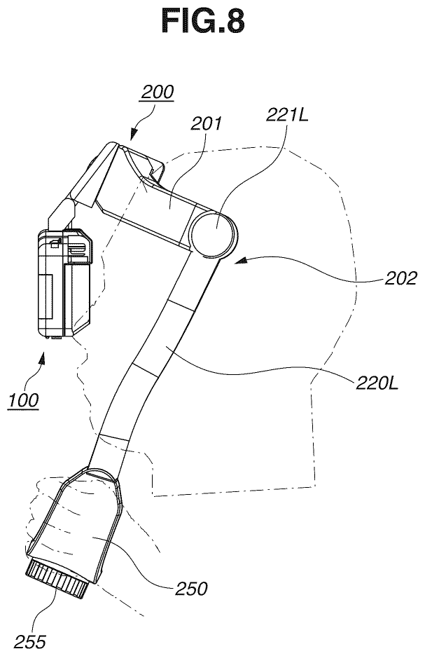

FIG. 7 is a diagram of a perspective view illustrating a state in which a user grips the image display apparatus according to the present exemplary embodiment in the HHD form. FIG. 8 is a diagram of a side view illustrating a state in which the user grips the image display apparatus according to the present exemplary embodiment in the HHD form.

In the above-described image display apparatus in the HMD form, the deformation portion 202 is configured to be rotatable relative to the forehead contact portion 201 at the two rotation portions 221L and 221R. The belts 220L and 220R and the rear head contact portion 250 rotate at the rotation portions 221L and 221R to drop down below the image display unit 100. In this way, the image display apparatus can be shifted into the HHD form.

In the HHD form, the rear head contact portion 250 with which the user's back of the head (rear head) is brought into contact in the HMD form is located in front of and on the lower side of the user's face, and the rear head contact portion 250 becomes the grip portion to be gripped by the user.

As illustrated in FIG. 8, in a case where the position of the rear head contact portion 250 used as the grip portion is located at approximately the illustrated position and angle relative to the user's head, the user can grip the grip portion without needing to lift the user's hands from a state where the user places the user's elbows at the user's sides. In addition, the angle of the user's hands gripping the grip portion is in a natural state. Thus, the user is less likely to get tired, which is preferable.

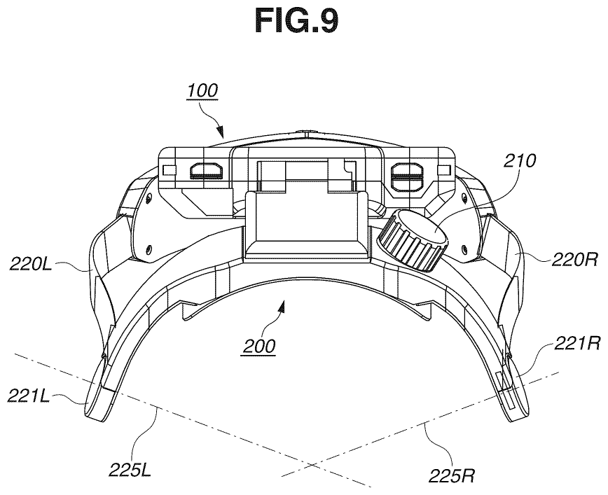

FIG. 9 is a schematic diagram illustrating the head mounting unit 200 of the image display apparatus according to the present exemplary embodiment in the HHD form as seen from above.

In the present exemplary embodiment, the deformation portion 202 is configured in such a way that its stiffness increases by rotating and bending at the rotation portions 221L and 221R. More specifically, as illustrated in FIG. 9, rotation axes 225L and 225R of the rotation portions 221L and 221R in the deformation portion 202 are arranged to intersect with each other, not coaxially. With this configuration, when the deformation portion 202 deforms to shift the image display apparatus from the HMD form to the HHD form by rotating at the rotation portions 221L and 221R, the left and right belts 220L and 220R are twisted to increase their stiffness in a direction in which the belt lengths change to cause displacement in this direction to be difficult.

The left and right belts 220L and 220R are configured to be adjusted flexibly in a lengthwise direction to match the circumferential length of the user's head in the HMD form. Thus, when the deformation portion 202 is deformed to shift the image display apparatus into the HHD form as it is, the distance between the image display unit 100 and the rear head contact portion 250 serving as a grip portion in the HHD form becomes easily changeable, which may hinder the image observation. To prevent such an issue, according to the present exemplary embodiment, the rotation axes 225L and 225R of the rotation portions 221L and 221R are made to intersect with each other, not to be coaxial as described above, and the belts 220L and 220R are twisted to increase their stiffness. In this way, the flexibility of the belts 220L and 220R required in the HMD form and the position stability of the image display unit 100 required in the HHD form can both be satisfied.

As described above, according to the present exemplary embodiment, the image display apparatus easily switchable between the HMD form and the HHD form and usable without adding or replacing any component can be achieved. The image display apparatus allowing a user to perform a stable image observation without causing the distance between the rear head contact portion 250 that becomes the grip portion in the HHD form and the image display unit 100 to change unexpectedly can be obtained.

A second exemplary embodiment according to the present disclosure will now be described.

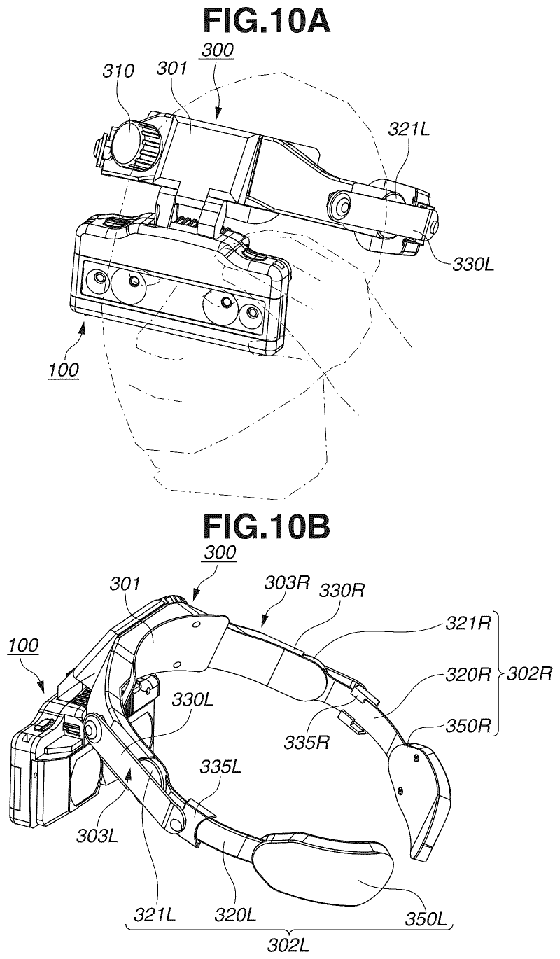

FIGS. 10A and 10B are schematic diagrams each illustrating a state in which the image display apparatus according to the present exemplary embodiment in the HMD form is mounted on the user's head. More specifically, FIG. 10A is a diagram of a perspective view illustrating a state in which a user wears the image display apparatus on the user's head, and FIG. 10B is a diagram of a perspective view illustrating the image display apparatus as seen from the back side.

The image display unit 100 according to the present exemplary embodiment has the same configuration as that described above according to the first exemplary embodiment.

The image display apparatus includes the image display unit 100 described above and a head mounting unit 300 that supports the image display unit 100. The head mounting unit 300 includes a forehead contact portion 301, a pair of deformation portions 302L and 302R, and a pair of additional deformation portions 303L and 303R. The forehead contact portion 301 is a first contact portion that is brought into contact with the user's forehead when the user wears the image display apparatus on the user's head and includes a vertical direction adjustment dial 310.

The deformation portions 302L and 302R are connected with respective end portions of the forehead contact portion 301, and extend in an arc shape. The additional deformation portions 303L and 303R are respectively provided in parallel with the deformation portions 302L and 302R. The image display unit 100 is swingably connected and fixed to the forehead contact portion 301.

The deformation portions 302L and 302R respectively include belts 320L and 320R, rotation portions 321L and 321R connecting the forehead contact portion 301 and the belts 320L and 320R, and rear head contact portions 350L and 350R that are the second contact portions in contact with the back of the head (rear head) of the user when the user wears the image display unit 100 on the user's head. The rear head contact portions 350L and 350R are separate from each other. The additional deformation portions 303L and 303R have higher stiffness than the deformation portions 302L and 302R, and bend and drop down in conjunction with the bending operations of the deformation portions 302L and 302R, respectively.

According to the present exemplary embodiment, the image display apparatus in the HMD form is the first use form.

In the HMD form, the deformation portions 302L and 302R respectively extend integrally with the forehead contact portion 301 in an arc shape, without bending (in non-bending state) at the rotation portions 321L and 321R. The additional deformation portions 303L and 303R respectively extend without bending approximately in parallel with the deformation portions 302L and 302R. The user can observe an image in a hands-free manner by attaching the head mounting unit 300 with the image display unit 100 connected thereto so as to fit around the user's head by the left and right deformation portions 302L and 302R.

The image display apparatus according to the present exemplary embodiment can be shifted from the HMD form to the HHD form (second use form) as the deformation portions 302L and 302R and the additional deformation portions 303L and 303R bend.

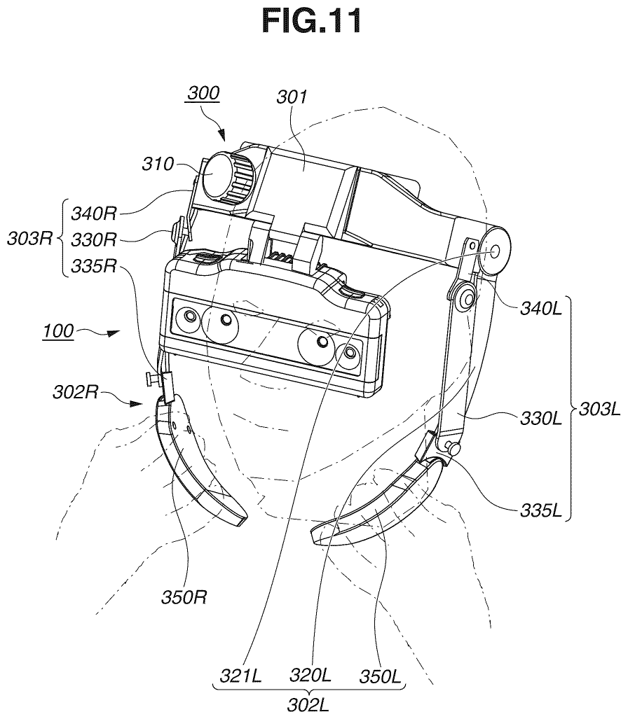

FIG. 11 is a diagram of a perspective view illustrating a state in which a user grips the image display apparatus according to the present exemplary embodiment in the HHD form.

In the image display apparatus in the HMD form, the deformation portions 302L and 302R are configured to be rotatable respectively at the rotation portions 321L and 321R relative to the forehead contact portion 301. The forehead contact portion 301 includes the vertical direction adjustment dial 310. The additional deformation portions 303L and 303R are configured to be rotatable relative to the forehead contact portion 301 respectively by operating levers 340L and 340R. At the respective rotation portions 321L and 321R, the belts 320L and 320R and the rear head contact portions 350L and 350R rotate to drop down. In conjunction with the rotation of the deformation portions 302L and 302R, the additional deformation portions 303L and 303R are respectively rotated to drop down by operating the levers 340L and 340R. In this way, the image display apparatus can be changed into the HHD form. In the HHD form, the rear head contact portions 350L and 350R with which the back of the head of the user is brought into contact in the HMD form are positioned in front of and on the lower side of the user's face, and the rear head contact portions 350L and 350R become the grip portions respectively held with the user's left and right hands.

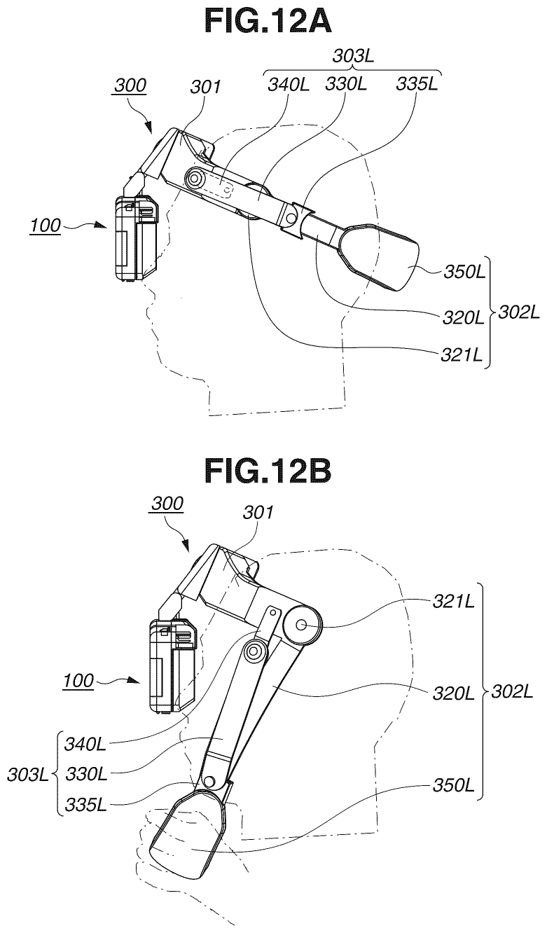

FIGS. 12A and 12B are diagrams of side views illustrating use states of the image display apparatus according to the present exemplary embodiment. More specifically, FIG. 12A illustrates the HMD form, and FIG. 12B illustrates the HHD form. In FIGS. 12A and 12B, the left deformation portion 302L and the left additional deformation portion 303L of the head mounting unit 300 are shown, but in the descriptions below, with reference to FIG. 11, the deformation portions 302L and 302R, and the additional deformation portions 303L and 303R, will be described.

The additional deformation portions 303L and 303R respectively include rods 330L and 330R, levers 340L and 340R, and sliders 335L and 335R. The rods 330L and 330R are higher in stiffness than the belts 320L and 320R of the deformation portions 302L and 302R. The levers 340L and 340R are rotatably connected with the rods 330L and 330R. The sliders 335L and 335R are configured to be movable on the belts 320L and 320R, and rotatably connected with the rods 330L and 330R, respectively.

When the deformation portions 302L and 302R are deformed to shift the image display apparatus from the HMD form in FIG. 12A to the HHD form in FIG. 12B, the levers 340L and 340R rotate along with the rotation portions 321L and 321R of the belts 320L and 320R, respectively. With this operation, the rods 330L and 330R are pressed down to move the sliders 335L and 335R connected with the rods 330L and 330R toward the rear head contact portions 350L and 350R along the belts 320L and 320R, respectively. As the image display apparatus is shifted into the HHD form as described above, the levers 340L and 340R, the rods 330L and 330R, and the sliders 335L and 335R do not move the rear head contact portions 350L and 350R upward in the head mounting unit 300. Thus, when the user grips the rear head contact portions 350L and 350R, it is possible to prevent the position of the image display unit 100 from dropping down or bouncing up and down due to the flexibility of the belts 320L and 320R.

When the image display apparatus is shifted from the HHD form in FIG. 12B to the HMD form in FIG. 12A, through the opposite process described above, the image display apparatus turns into a state where the user can wear the image display apparatus on the user's head using the elasticity of the belts 320L and 320R.

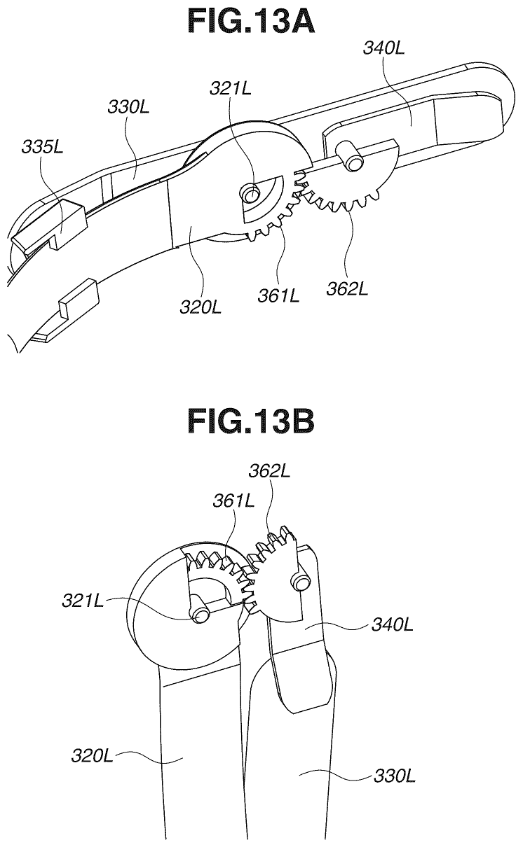

FIGS. 13A and 13B are schematic diagrams illustrating an interlocking mechanism of the deformation portion 302L and the additional deformation portion 303L of the image display apparatus according to the present exemplary embodiment. More specifically, FIG. 13A illustrates the interlocking mechanism in the HMD form, and FIG. 13B illustrates the interlocking mechanism in the HHD form. In FIGS. 13A and 13B, and in the descriptions below, only the left deformation portion 302L and the left additional deformation portion 303L are described, but the operations of the right deformation portion 302R and the right additional deformation portion 303R are similar to those of the left deformation portion 302L and the left additional deformation portion 303L.

As illustrated in FIGS. 13A and 13B, in the present exemplary embodiment, for example, the rotation portion 321L of the deformation portion 302L is provided with a gear 361L, the lever 340L of the additional deformation portion 303L is provided with a gear 362L, and the gear 361L and the gear 362L engage with each other. With this configuration, when the image display apparatus is shifted from the HMD form to the HHD form or from the HHD form to the HMD form, the lever 340L rotates in conjunction with the rotation of the belt 320L.

As described above, according to the present exemplary embodiment, the image display apparatus usable by easily switching between the HMD form and the HHD form without adding or replacing any component can be achieved. The image display apparatus allowing a user to perform a stable image observation without causing the distance between the rear head contact portions 350L and 350R that become the grip portions in the HHD form and the image display unit 100 to change unexpectedly can be obtained.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-123336, filed Jul. 30, 2024, the entirety of which is incorporated herein by reference.

What is claimed is:

1. An image display apparatus comprising:
a display unit configured to display an image; and
a support unit configured to support the display unit and to be mountable on a user's head,
wherein the support unit includes a deformation portion configured to bend at a predetermined part and drop down below the display unit.

2. The image display apparatus according to claim 1,
wherein the support unit includes a first contact portion configured to contact a user's forehead and to which the display unit is connected, and
wherein the deformation portion includes a flexible belt portion connected to the first contact portion at the predetermined part.

3. The image display apparatus according to claim 1,
wherein the predetermined part is a rotation portion, and
wherein the deformation portion is configured to rotate at the rotation portion.

4. The image display apparatus according to claim 3,
wherein the deformation portion has an arc shape and is configured to bend at rotation portions located at two positions, and
wherein the rotation axes of the rotation portions located at the two positions intersect with each other.

5. The image display apparatus according to claim 1, wherein the deformation portion includes a second contact portion configured to contact a back of the head of a user.

6. The image display apparatus according to claim 1, wherein the deformation portion is configured to be adjustable in length in an extending direction.

7. The image display apparatus according to claim 1, wherein bending at the predetermined part increases the stiffness of the deformation portion.

8. The image display apparatus according to claim 1, wherein the support unit further includes an additional deformation portion arranged in parallel with the deformation portion and configured to bend and drop in conjunction with a bending operation of the deformation portion.

9. The image display apparatus according to claim 8, wherein the additional deformation portion is higher in stiffness than the deformation portion.

10. The image display apparatus according to claim 8,
wherein the deformation portion comprises a pair of deformation portions and the additional deformation portion comprises a pair of additional deformation portions,
and wherein each one of the pair of additional deformation portions is arranged in parallel with a corresponding one of the pair of deformation portions.

11. The image display apparatus according to claim 1, wherein a first use form in which the support unit is mounted on the user's head in a state where the deformation portion is not bent at the predetermined part, and a second use form in which the support unit is gripped by a user in a state where the deformation portion is bent at the predetermined part are selectively employable.
